(19) United States
(12) Patent Application Publication
(10) Pub. No.: US 2018/0304651 A1
(43) Pub. Date: Oct. 25, 2018

(54) PRINTER

(71) Applicant: TOSHIBA TEC KABUSHIKI KAISHA, Tokyo (JP)

(72) Inventor: Yoshimasa Gojo, Izunokuni Shizuoka (JP)

(21) Appl. No.: 15/924,497

(22) Filed: Mar. 19, 2018

(30) Foreign Application Priority Data
Apr. 25, 2017 (JP) 2017-086080

(51) Int. Cl. B41J 11/70; B31D 1/02; B65H 16/00; B65H 35/06; B65H 43/00; B65H 20/02; B41J 3/407; B41J 29/17; B41J 29/46

(52) U.S. Cl. CPC B41J 11/703; B31D 1/026; B31D 1/027; B65H 16/005; B65H 35/06; B65H 43/00; B65H 2701/192; B41J 3/4075; B41J 29/17; B41J 29/46; B31D 2201/02; B31D 1/021; B65H 20/02

(57) ABSTRACT

A printer includes a frame including a discharge port, a fixed blade fixed to the frame, a movable blade attached to the frame so that the movable blade is opposite to the fixed blade across the discharge port, a driving mechanism that reciprocally moves the movable blade between a cutting position and a non-cutting position, a motor for the driving mechanism, a sensor configured to detect that the movable blade has reciprocated once between the cutting and non-cutting positions, and a control unit configured to control the motor to drive the driving mechanism at the time of cutting the label, measure a time taken by the movable blade to reciprocate once between the non-cutting and cutting positions, compare the measured time with a threshold value, and determine that a cleaning timing has been reached if the measured time exceeds the threshold value.

### CROSS-REFERENCE TO RELATED APPLICATION

This application is based upon and claims the benefit of priority from Japanese Patent Application No. 2017-086080, filed in Apr. 25, 2017, the entire contents of which are incorporated herein by reference.

### FIELD

Embodiments described herein relate generally to a printer that performs printing on a label.

### BACKGROUND

A printer that performs printing on a belt-shaped or rolled label, which has an adhesive layer on the rear side thereof, and cuts the label at a predetermined length so that the label can be attached on an object with the adhesive layer, is known. Another type of printer includes a cutter unit for cutting the belt-shaped label with a movable blade that reciprocates with respect to a fixed blade. If the cutter unit repeatedly cuts the label, the adhesive layer or adhesive material accumulates between the fixed blade and the movable blade. If the adhesive material accumulates on the fixed blade and the movable blade, the sharpness of the cutter unit is deteriorated. As a result, it is likely that deterioration of a cut surface occurs and movement of the movable blade is hindered by the accumulated adhesive material to cause failure in cutting of the label by the cutter unit.

Therefore, the cutter unit is repeatedly cleaned to maintain the sharpness of the cutter unit to prevent the occurrence of the failure in cutting by the cutter unit. In general, the cleaning is performed, as an example, at the time the sharpness is actually deteriorated or after the printing is performed a fixed number of times. However, the cleaning may be performed too late, i.e., after a problem actually occurs. Also, if the cleaning is performed after the printing is performed a fixed number of times, occurrence of a problem is likely because different labels may cause failure in cutting at different times.

### DESCRIPTION OF THE DRAWINGS

FIG. 1 is a perspective view illustrating a printer according to an embodiment;

FIG. 2 is a block diagram illustrating the printer;

FIG. 3 is a perspective view, partly cut away to show a movable blade of a cutter unit at a non-cutting position;

FIG. 4 is a perspective view, partly cut away to show of the cutter unit at a cutting position; and

FIG. 5 is a flowchart illustrating a control processing of the printer.

### DETAILED DESCRIPTION

According to one embodiment, a printer includes a frame, a fixed blade, a movable blade, a driving mechanism, a driving motor, a sensor, and a control unit. The frame includes a discharge port for discharging a label having an adhesive layer. The fixed blade is fixed to the frame, and the movable blade is attached to the frame so that the movable blade is opposite to the fixed blade across the discharge port. The movable blade is configured to be moved between a cutting position at which position the movable blade cuts the label fed through the discharge port in cooperation with the fixed blade, and a non-cutting position. The driving mechanism is configured to reciprocally move the movable blade between the cutting position and the non-cutting position, and the driving motor is configured to drive the driving mechanism. The sensor is configured to detect that the movable blade has reciprocated once between the cutting position and the non-cutting position. The control unit is configured to control the driving motor to drive the driving mechanism at the time of cutting the label, measure a time taken by the movable blade to reciprocate once between the non-cutting position and the cutting position, compare the measured time with a threshold value, and determine that a cleaning timing of the fixed blade and the movable blade has been reached if the measured time exceeds the threshold value.

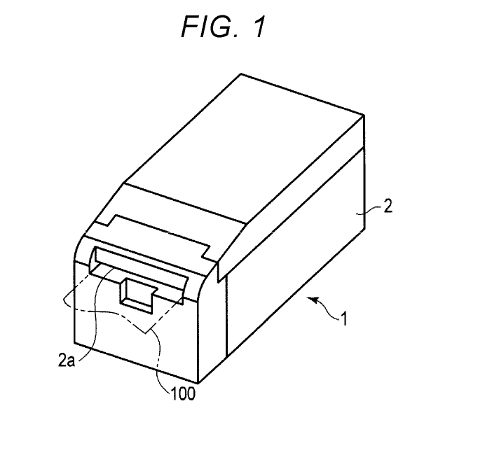

A printer 1 according to an embodiment is described below with reference to FIGS. 1 to 5.

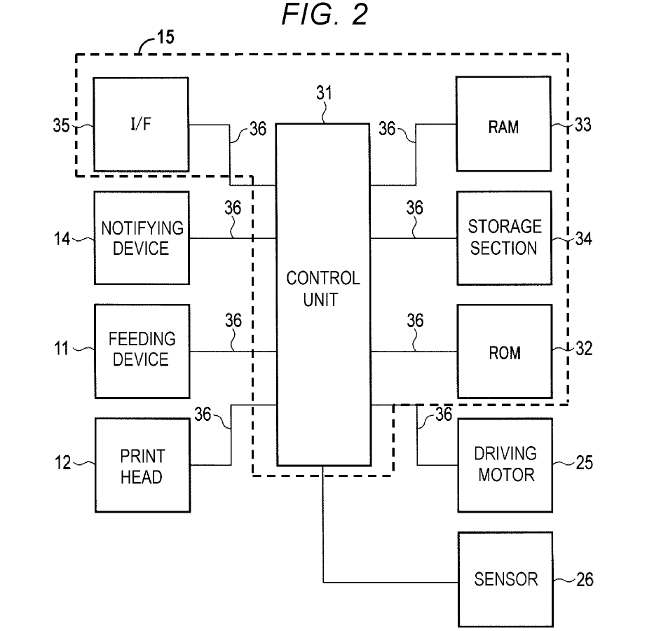

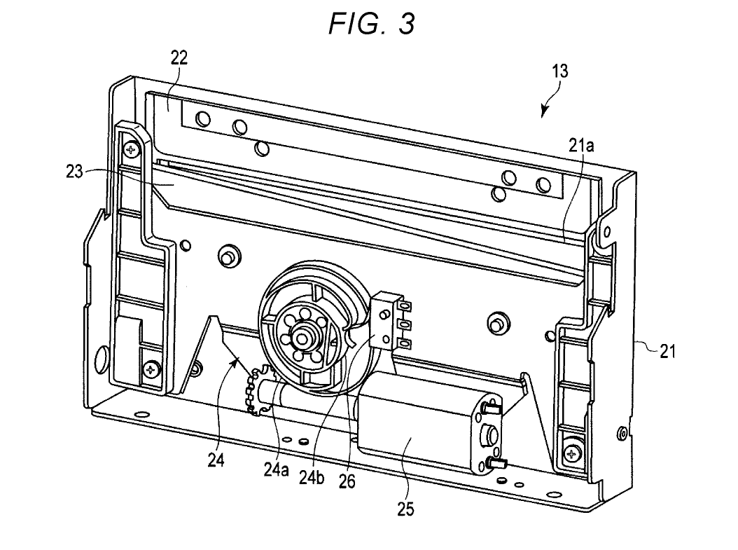

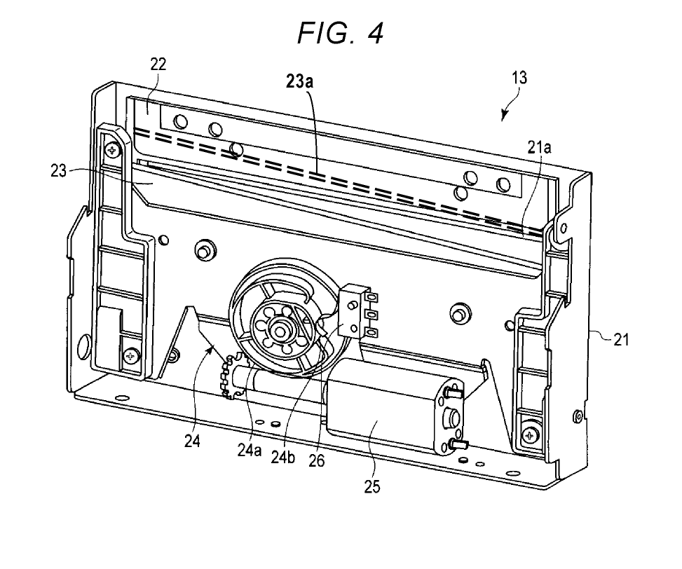

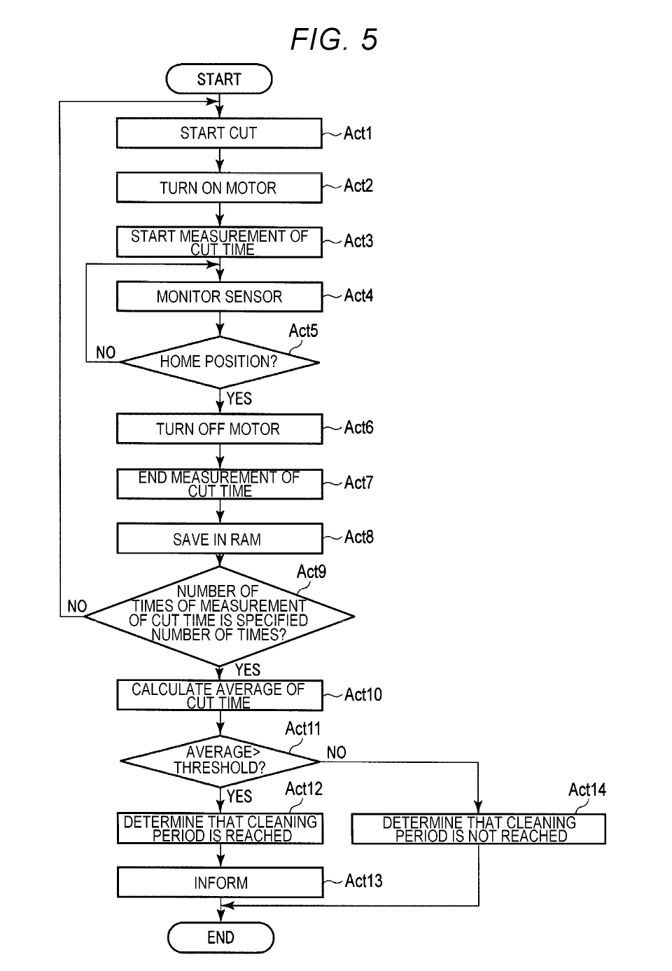

FIG. 1 is a perspective view illustrating the printer 1 according to the present embodiment. FIG. 2 is a block diagram illustrating the printer 1. FIGS. 3 and 4 are perspective views, partly cut away to show the inside of a cutter unit 13 used in the printer 1. FIG. 3 is a diagram illustrating a state before a label 100 is cut. FIG. 4 is a diagram illustrating a state after the label 100 is cut. FIG. 5 is a flowchart illustrating detection of a cleaning timing of the cutter unit 13 of the printer 1.

As shown in FIGS. 1 and 2, the printer 1 includes a feeding device 11, a print head 12, the cutter unit 13, a notifying device 14, and a control device 15 in a housing 2. The printer 1 houses a belt-shaped label 100, e.g., rolled label, in the housing 2.

As the label 100, for example, a belt-shaped heat sensitive paper including an adhesive layer is used. The label 100 is, for example, a liner-less label. Alternatively, label 100 may not use the heat sensitive paper and instead may be a label having a liner.

The feeding device 11 feeds the label 100 by a predetermined length and discharges the cut label 100 from a paper discharge port 2a provided in the housing 2.

The print head 12 is, for example, a thermal print head. As the print head 12, a print head having a different printing method can be appropriately selected according to a type of the label 100 in use. For example, if a base material of the label 100 is not heat sensitive, the print head 12 may be an inkjet print head.

The cutter unit 13 includes a frame 21, a fixed blade 22, a movable blade 23, a driving mechanism 24, a driving motor 25, and a sensor 26. The frame 21 is a rectangular plate. The frame 21 includes a discharge port 21a through which the label 100 is fed. The frame 21 is fixed in the housing 2 such that the discharge port 21a is opposed to the paper discharge port 2a. The discharge port 21a is formed to extend lengthwise in one direction. The length of the discharge port 21a in the one direction is larger than the width of the label 100.

The fixed blade 22 is fixed at a position of the frame 21 adjacent to the discharge port 21a. The fixed blade 22 is provided at one of the sides of the discharge port 21a in a direction orthogonal to the longitudinal direction of the discharge port 21a. As a specific example, the fixed blade 22 is arranged at the upper end side when the frame 21 is fixed to the housing 2. The tip of the fixed blade 22 is arranged along the upper end edge of the discharge port 21a.

The movable blade 23 is provided at a position of the frame 21 opposite to the fixed blade 22 across the discharge port 21a. The movable blade 23 is arranged at the other side of the discharge port 21a in the direction orthogonal to the longitudinal direction of the discharge port 21a. As a specific example, the movable blade 23 is arranged at the lower end side of the discharge port 21a.

The movable blade 23 is arranged to be capable of approaching and separating from the fixed blade 22. The tip of the movable blade 23 moves to the rear end side of the fixed blade 22 over the tip of the fixed blade 22 so that the movable blade 23 is capable of moving between a cutting position at which the tip of the movable blade 23 overlaps the fixed blade 22 and a non-cutting position (shown in FIG. 3) at which the tip of the movable blade 23 is separated from the tip of the fixed blade 22. The movable blade 23 moves to the cutting position to cut the label 100 fed through the discharge port 21a in cooperation with the fixed blade 22. The tip of the movable blade 23 at the non-cutting position inclines with respect to the longitudinal direction of the discharge port 21a.

The driving mechanism 24, when driven, reciprocally moves the movable blade 23. The driving mechanism 24 reciprocally moves the movable blade 23 between the cutting position and the non-cutting position. The driving mechanism 24 includes a member 24a that rotates once when the movable blade 23 reciprocates once between the non-cutting position and the cutting position. For example, the member 24a may be a component required for reciprocally moving the movable blade 23 if the component rotates once when the movable blade 23 reciprocates once or may be a component other than the component that reciprocally moves the movable blade 23. For example, the member 24a is a worm gear formed in a hollow disk shape. A cylindrical part coaxial with the worm gear is provided on a principal plane of the worm gear. The worm gear includes a recess 24b on a portion of the outer circumferential surface of the cylindrical part.

The driving motor 25 is driven if electric power is supplied from the outside and drives the driving mechanism 24.

The sensor 26 detects a home position of the driving mechanism 24 at the time the movable blade 23 is at the non-cutting position. The sensor 26 detects the recess 24b on the outer circumferential surface of the member 24a at the home position. In other words, the sensor 26 detects the recess 24b if the movable blade 23 is at the non-cutting position.

The notifying device 14 notifies a user of information. In the present embodiment, the notifying device 14 notifies the user of information concerning at least a cleaning timing of the cutter unit 13. The notifying device 14 is, for example, an LED. The notifying device 14 emits light to notify the user of information concerning the cleaning time.

The control device 15 is equipped with a control unit 31 such as a CPU (Central Processing Unit). The control device 15 includes a ROM (Read Only Memory) 32, i.e., internal storage device, for storing a control program, a RAM (Random Access Memory) 33 for storing data, a storage section 34 in which a database of a threshold value and the like is stored, and an interface (I/F) 35 for connecting to an external apparatus.

The threshold value is determined and stored in the storage unit 34 in advance at the time of shipment from the factory of the printer 1. The threshold value indicates a time period from a time at which the sensor 26 detects the recess 24b indicating the home position to a time at which the sensor 26 detects the recess 24b again if the movable blade 23 reciprocates between the non-cutting position and the cutting position once.

The control unit 31 is connected to the ROM 32, the RAM 33, the storage section 34, and the I/F 35 via a bus line 36 such as an address bus or a PCI (Peripheral Component Interconnect) bus. The control unit 31 is connected to the feeding device 11, the print head 12, the driving motor 25 of the cutter unit 13, and the notifying device 14 via a bus line 36 or the like.

The control unit 31 has a function of controlling the print head 12 to perform printing on the label 100 and controlling the feeding device 11 to feed the label 100 by the predetermined length according to the control program stored in the ROM 32. The control unit 31 also has a function of controlling the driving motor 25 to move the movable blade 23 from the non-cutting position, i.e., home position, to the cutting position and vice versa to cut the label 100 if the label 100 is fed by the predetermined length. The control unit 31 also has a function of stopping the driving motor 25 by determining that the movable blade 23 moves from the non-cutting position to the cutting position and vice versa if the recess 24b is detected.

The control unit 31 has a function of measuring a time period from the time at which the sensor 26 detects the recess 24b to the time at which the sensor 26 detects the recess 24b again at the time of cutting the label 100, that is, a time required by the movable blade 23 to reciprocally move once. The control unit 31 has a function of storing the measured time in the storage section 34. The control unit 31 has a function of determining a cleaning timing of the fixed blade 22 and the movable blade 23. The control unit 31 calculates, if the number of times the measured time is stored reaches a predetermined number. The control unit 31 compares an average time for the measured time with the threshold value to determine that the cleaning timing of the fixed blade 22 and the movable blade 23 comes if the average time is greater than the threshold value. The control unit 31 has a function of controlling the notifying device 14 to notify the user of the information if determining that the cleaning timing comes.

A method of cutting the label 100 by the cutter unit 13 of the printer 1 is described with reference to the flowchart of FIG. 5.

First, after the feeding device 11 feeds the printed label 100 by a predetermined length, the control unit 31 determines to start cutting of the label 100 (Act 1). The control unit 31 drives the driving motor 25 (Act 2). At the same time, the control unit 31 starts a timer to measure the time required for the cutting of the label 100 (Act 3). If the driving motor 25 drives the driving mechanism 24, as shown in FIG. 3, the movable blade 23 moves from the non-cutting position, i.e., home position, to the cutting position (tip edge of movable blade 23a in the cutting position shown in broken lines) and returns from the cutting position to the non-cutting position, shown in FIG. 4. If the driving motor 25 is driven, the positional relationship between the sensor 26 and the recess 24b is immediately broken and thus the sensor 26 does not detect the recess 24b.

Therefore, the control unit 31 monitors the sensor 26 (Act 4) and, after the driving motor 25 is activated, confirms whether the driving mechanism 24 returns to the home position. In other words, the control unit 31 confirms whether the sensor 26 detects the recess 24b again (Act 5). If the sensor 26 does not detect the recess 24b (NO in Act 5), the control section 31 returns to the processing in Act 4. If the sensor 26 detects the recess 24b (YES in Act 5), the control unit 31 stops the driving motor 25 (Act 6). At the same time, the control unit 31 stops the timer and measures the elapsed time (Act 7). The control unit 31 stores the measured time into the RAM 33 (Act 8).

The control unit 31 determines whether the number of times of the measurement of the time required for the cutting of the label 100, in other words, the number of times of cutting of the label 100 reaches a specified number of times (Act 9). The specified number of times can be set as appropriate. The specified number of times may be once or may be a plurality of times. However, the specified number of times is desirably set to the plurality of times because accuracy in determination of the cleaning timing improves with the increase in the number of times.

If the number of times of the measurement of the time required for the cutting of the label 100 does not reach the specified number of times (NO in Act 9), the control unit 31 returns to the processing in Act 1. If the number of times of the measurement of the time required for the cutting of the label 100 reaches the specified number of times (YES in Act 9), the control unit 31 calculates an average time (Act 10). Subsequently, the control unit 31 determines whether the calculated average time is larger than the threshold value (Act 11). If the calculated average time is larger than the threshold value (YES in Act 11), the control unit 31 determines that the adhesive material of the adhesive layer has adhered to the fixed blade 22 and the movable blade 23 and a moving speed of the movable blade 23 is decreased thereby. The control unit 31 determines that the cleaning timing of the fixed blade 22 and the movable blade 23 has been reached (Act 12). The control unit 31 notifies the user of information indicating that the cleaning timing has been reached via the notifying device 14 (Act 13).

If the calculated average time is smaller than the threshold value in Act 11 (NO in Act 11), the control unit 31 determines that the cleaning timing has not yet been reached (Act 14). Therefore, the control unit 31 does not notify the user of the information.

By repeatedly performing the processes described above, the printer 1 repeatedly performs the cutting of the label 100. If the cleaning timing comes, the printer 1 notifies the user of the information indicating that the cleaning timing has been reached.

The printer 1 compares the time required for the cutting of the label 100 with the threshold value. If the actual time is greater than the threshold value, the printer 1 determines that the cleaning timing has been reached. At the time of cutting of the label 100, the printer 1 can determine that glue and the like of the adhesive layer has adhered to the fixed blade 22 and the movable blade 23 and thus the sharpness of the cutter unit 13 has been deteriorated.

By setting the threshold value as the time required for the cutting of the label 100 at the time of shipment, the printer 1 determines the cleaning timing on the basis of a time required for the cutting of the label 100 in a state in which the adhesive material does not adhere on the cutting unit. The printer 1 can detect the cleaning timing with the same accuracy as in the present embodiment even if the type of the label 100 or the material of the adhesive layer on the label 100 is changed.

The notifying device 14 of the printer 1 notifies a user of the information indicating that the cleaning timing has been reached. Therefore, the user can easily know that the cleaning timing has been reached. The notifying device 14 notifies the user of the information with light emission. However, the notifying device 14 may notify the user of the information with sound, display on a display device, and transmission of the information to an external apparatus.

As described above, the printer 1 in the present embodiment can detect the cleaning timing of the cutter unit 13 with a high accuracy.

While certain embodiments have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A printer comprising:
a frame including a discharge port for discharging a label having an adhesive layer;
a fixed blade fixed to the frame;
a movable blade attached to the frame so that the movable blade is opposite to the fixed blade across the discharge port, wherein the movable blade is configured to be moved between a cutting position at which position the movable blade cuts the label fed through the discharge port in cooperation with the fixed blade, and a non-cutting position;
a driving mechanism configured to reciprocally move the movable blade between the cutting position and the non-cutting position;
a driving motor configured to drive the driving mechanism;
a sensor configured to detect that the movable blade has reciprocated once between the cutting position and the non-cutting position; and
a control unit configured to control the driving motor to drive the driving mechanism at the time of cutting the label, measure a time taken by the movable blade to reciprocate once between the non-cutting position and the cutting position, compare the measured time with a threshold value, and determine that a cleaning timing of the fixed blade and the movable blade has been reached if the measured time exceeds the threshold value.

2. The printer according to claim 1, wherein the fixed blade is arranged at an upper side of the discharge port, and the movable blade is arranged at a lower side of the discharge port.

3. The printer according to claim 1, further comprising:
a notifying device configured to notify a user that the cleaning timing has been reached.

4. The printer according to claim 3, wherein the notifying device is an LED.

5. The printer according to claim 1, wherein the driving mechanism includes a rotational body that rotates once if the movable blade reciprocates once between the non-cutting position and the cutting position, and the sensor detects a part of the rotational body.

6. The printer according to claim 5, wherein the rotational body has a recess and the sensor detects the recess.

7. A printer comprising:
a frame including a discharge port for discharging a label having an adhesive layer;
a fixed blade fixed to the frame;
a movable blade attached to the frame so that the movable blade is opposite to the fixed blade across the discharge port, wherein the movable blade is configured to be moved between a cutting position at which position the movable blade cuts the label fed through the discharge port in cooperation with the fixed blade, and a non-cutting position;
a driving mechanism configured to reciprocally move the movable blade between the cutting position and the non-cutting position;
a driving motor configured to drive the driving mechanism;
a sensor configured to detect that the movable blade has reciprocated once between the cutting position and the non-cutting position; and
a control unit configured to control the driving motor to drive the driving mechanism at the time of cutting the label, measure a time taken by the movable blade to reciprocate once between the non-cutting position and the cutting position a plurality of times, compare an average of the measured times with a threshold value, and determine that a cleaning timing of the fixed blade and the movable blade has been reached if the average of the measured times exceeds the threshold value.

8. The printer according to claim 7, wherein the fixed blade is arranged at an upper side of the discharge port, and the movable blade is arranged at a lower side of the discharge port.

9. The printer according to claim 7, further comprising:
a notifying device configured to notify a user that the cleaning timing has been reached.

10. The printer according to claim 9, wherein the notifying device is an LED.

11. The printer according to claim 7, wherein the driving mechanism includes a rotational body that rotates once if the movable blade reciprocates once between the non-cutting position and the cutting position, and the sensor detects a part of the rotational body.

12. The printer according to claim 11, wherein the rotational body has a recess and the sensor detects the recess.

13. A method of determining a cleaning time for a cutter installed in a printer, wherein the cutter includes a fixed blade fixed to a frame of the printer and a movable blade attached to the frame so that the movable blade is opposite to the fixed blade across a discharge port of the printer, said method comprising:
discharging a label having an adhesive layer through the discharge port;
moving the blade to a cutting position to cut the label fed through the discharge port in cooperation with the fixed blade and then returning the blade to a non-cutting position;
measuring a time taken for the movable blade to reciprocate once between the cutting position and the non-cutting position; and
notifying a user of the printer that the cleaning time has arrived based on the measured time and a not-to-exceed time value.

14. The method according to claim 13, wherein the time taken for the movable blade to reciprocate once between the cutting position and the non-cutting position is measured a plurality of times, and an average of the measured times is compared against the non-to-exceed time value to determine whether or not to notify the user that the cleaning time has arrived.

15. The method according to claim 14, wherein the notifying includes activating an LED.

16. The method according to claim 13, wherein the blade is moved through a driving mechanism that includes a rotational body driven by a motor.

17. The method according to claim 16, wherein the time is measured by:
determining that the rotational body is at a home position;
starting a timer when the rotational body is rotated out of the home position; and
stopping a timer when the rotational body returns to the home position.

18. The method according to claim 17, wherein the rotational body includes a recess and the recess is sensed to determine that the rotational body is at the home position.
